(19) United States
(12) Patent Application Publication
(10) Pub. No.: US 2022/0046851 A1
(43) Pub. Date: Feb. 17, 2022

(54) PEANUT DIGGER-SHAKER CONTROL SYSTEM

(71) Applicant: Kelley Manufacturing Company, Tifton, GA (US)

(72) Inventors: Matthew Rewis, Tifton, GA (US); Jason Morris, Tifton, GA (US); Bennie G. Branch, JR., Tifton, GA (US)

(73) Assignee: Kelley Manufacturing Company, Tifton, GA (US)

(21) Appl. No.: 17/402,733

(22) Filed: Aug. 16, 2021

Related U.S. Application Data
(60) Provisional application No. 63/065,614, filed on Aug. 14, 2020.

(51) Int. Cl. A01D 29/00; A01D 33/12

(52) U.S. Cl. CPC A01D 29/00; A01D 17/08; A01D 33/12

(57) ABSTRACT

A control system for use on a peanut harvester using a conveyor to elevate and relocate the peanut pods and attached plant material. The control system inputs the ground speed in the direction of travel and the conveyor speed, and outputs to an electronic flow control valve that is part of a hydraulic circuit between a hydraulic motor that drives the conveyor and a connection point that provides hydraulic power to the hydraulic motor. The control system uses an algorithm that compares the ground speed and the conveyor speed and varies the output to the flow control valve so that the conveyor speed is maintained at a defined percentage of ground speed. The defined percentage of ground speed is a user-controlled variable that can be adjusted on the go through the user interface portion of the control system.

### CROSS-REFERENCE TO RELATED APPLICATIONS

This application is a nonprovisional application that claims priority to and the benefit of the filing date of a U.S. provisional application having application Ser. No. 63/065,614, filed on Aug. 14, 2020, entitled “PEANUT DIGGER-SHAKER CONTROL SYSTEM,” which is hereby incorporated by reference herein in its entirety.

### BACKGROUND OF THE INVENTION

### Technical Field

This invention generally is in the field of control systems for peanut digger-shakers, and more specifically is in the field of control systems for maintaining the speed of a conveyor used with the peanut digger-shaker relative to the ground speed of the peanut digger-shaker.

### Prior Art

Peanuts grow underground attached to pegs, which are attached to stems of an above-ground vine. To harvest peanuts, the plant is dug from the ground, the peanut pods are separated from the plant vine and root material, and the peanut pods are dried.

Peanut harvesting is at least a two-stage process. The first stage comprises digging the peanut pods from the ground using, for example, a digger-shaker attached to a tractor. The digger-shaker is a machine that digs peanut pods from below ground level, elevates the complete peanut plant on a shaking conveyor, often powered by a hydraulic motor, and places the peanut pods and attached vine material on top of the ground, typically positioned in windrows. The second stage comprises using a harvester to separate the peanut pods from the plant vine and root material. Additional stages comprise of drying or further treating the peanut pods.

It has been found that digging losses can be minimized by synchronizing the conveyor speed to the ground speed of the digger. In an article in the July 2020 issue of the Peanut Grower, research was cited finding that optimum conveying speeds of 85% of the ground speed of the digger results in lower digging losses in Virginia type peanuts. Digging losses include peanut pods pulled off the vines and peanut pods being damaged during the digging and conveying processes. Synchronizing the conveyor speed of the ground speed of the digger allows for a more even and smooth flow of the peanut vines up the conveyor. While this research shows the importance of having the conveyor speed operating at the correct percentage of ground speed, this research does not account for certain special circumstances, such as the need to increase or decrease the speed of the conveyor, to operate the conveyor in a manual mode, or to set or adjust the speed of the conveyor when parked or being services.

### BRIEF SUMMARY OF THE INVENTION

Briefly, the present disclosure is a control system, method and computer program that are implemented on a machine that digs peanut pods from below ground level and places the peanut pods and attached vine material on top of the ground, where the machine uses a conveyor operated by a hydraulic motor to elevate and relocate the peanut pods and attached plant material.

In one embodiment of the invention, the control system comprises a controller configured to input the ground speed and the conveyor speed and to output a conveyor speed control signal to a flow varying device that is part of a hydraulic circuit that provides hydraulic power to the conveyor. The controller performs a conveyor speed control algorithm that compares the ground speed with the conveyor speed and varies the conveyor speed control signal output to the flow varying device so that the conveyor speed is maintained at a preselected percentage of the ground speed.

In accordance with a representative embodiment of the control system, it comprises a user interface (UI) that is in communication with the controller, and the preselected percentage of the ground speed is a user-controlled variable that can be adjusted by a user on the go through the UI.

In accordance with a representative embodiment of the control system, the UI is configured to allow a user to rapidly increase the preselected percentage of the ground speed.

In accordance with a representative embodiment of the control system, the UI is configured to allow a user to change from an Auto mode during which the controller automatically varies the conveyor speed control signal to maintain the conveyor speed at the preselected percentage of the ground speed to a Manual mode during which the user can cause the control system to change the conveyor speed by making one or more user inputs on the UI to manually set the conveyor speed to a desired conveyor speed.

In accordance with a representative embodiment of the control system, in the Manual mode, the control system changes the conveyor speed based on said one or more user inputs and disregards the ground speed input.

In accordance with a representative embodiment of the control system, the UI further provides an ability for the user to return to the Auto mode from the Manual mode at any point in time.

In accordance with a representative embodiment of the control system, the UI provides the user with the ability to set a minimum conveyor speed variable that the controller uses to set the conveyor speed control signal to thereby set the conveyor speed to a minimum conveyor speed.

In accordance with a representative embodiment of the control system, the minimum conveyor speed is used to decrease lag time in adjusting the conveyor speed to the preselected percentage of the ground speed when the machine increases speed from stationary to operating speed.

In accordance with a representative embodiment of the control system, the preselected percentage of the ground speed is a user-defined percentage set by a user.

In accordance with a representative embodiment of the control system, the UI provides a user with an ability to rapidly increase the conveyor speed by multiples of the preselected percentage.

In accordance with a representative embodiment of the control system, the UI provides the user with an ability to rapidly increase the conveyor speed by a user-defined speed increment.

In accordance with a representative embodiment of the control system, the flow varying device is an electronic flow control valve for varying the flow of hydraulic fluid in the hydraulic circuit.

In accordance with a representative embodiment of the control system, the hydraulic circuit comprises a first hydraulic circuit portion disposed on the digger-conveyor combination machine and a second hydraulic circuit portion disposed on a tractor that is coupled to the digger-conveyor combination machine. The first and second hydraulic circuit portions are coupled together at a tractor connection point on the tractor, and the electronic flow control valve is part of the first hydraulic circuit portion. In accordance with another representative embodiment of the control system, the electronic flow control valve is disposed on the tractor and the control system is in communication with, or an integral part of, a control system of the tractor that performs ISOBUS protocol.

In accordance with a representative embodiment of the method, the method comprises: in a controller of the control system, inputting the ground speed; inputting the conveyor speed; and performing a conveyor speed control algorithm that compares the ground speed with the conveyor speed and varies a conveyor speed control signal output to a flow varying device that is part of a hydraulic circuit that provides hydraulic power to the conveyor to maintain the conveyor speed at a preselected percentage of the ground speed.

In accordance with a representative embodiment of the computer program, the computer program comprises instructions for execution by the controller and is embodied on a non-transitory computer-readable medium and comprising: a first set of instructions for inputting the ground speed in the controller; a second set of instructions for inputting the conveyor speed; a third set of instructions for performing a conveyor speed control algorithm that compares the ground speed with the conveyor speed and produces a conveyor speed control signal; and a fourth set of instructions that output the conveyor speed control signal from the controller to a flow varying device that is part of a hydraulic circuit that provides hydraulic power to the conveyor. The conveyor speed control signal is varied by the third set of instructions to maintain the conveyor speed at a preselected percentage of the ground speed.

These features, and other features and advantages of the present disclosure will become more apparent to those of ordinary skill in the relevant art when the following detailed description of the preferred embodiments is read in conjunction with the appended drawings.

### BRIEF DESCRIPTION OF THE DRAWINGS

FIG. 1 is a flow diagram exemplifying the inputs and outputs of the control system of the present disclosure.

FIG. 2 is a flow diagram of the logic flow of the control system of the present disclosure.

FIG. 3 shows a prior art digger-shaker combination with which the present disclosure can be used.

FIG. 4A shows a representative controller mounted on the window of a representative tractor suitable for use with the present disclosure.

FIG. 4B shows the controller of FIG. 4A with a first representative display screen.

FIG. 4C shows the controller of FIG. 4A with a second representative display screen.

FIG. 5 shows a representative electronic flow control valve operated by the controller of FIGS. 4A-4C and mounted on a representative digger-shaker combination suitable for use with the present disclosure.

FIG. 6 illustrates a block diagram of the controller/user interface of the control system shown in FIG. 1 in accordance with a representative embodiment.

### DETAILED DESCRIPTION OF PREFERRED EMBODIMENTS

A few representative, or exemplary, embodiments of the control system and method are described below in detail. In the following detailed description, a few exemplary, or representative, embodiments are described to demonstrate the inventive principles and concepts. For purposes of explanation and not limitation, representative embodiments disclosing specific details are set forth in order to provide a thorough understanding of an embodiment according to the present disclosure. However, it will be apparent to one having ordinary skill in the art having the benefit of the present disclosure that other embodiments that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present disclosure.

As used in the specification and appended claims, the terms “a,” “an,” and “the” include both singular and plural referents, unless the context clearly dictates otherwise. Thus, for example, “a device” can mean one device or plural devices.

Relative terms may be used to describe the various elements' relationships to one another, as illustrated in the accompanying drawings. These relative terms are intended to encompass different orientations of the device and/or elements in addition to the orientation depicted in the drawings. For example, terms such as “over,” “above,” “below,” “top,” “bottom,” “upper” and “lower” may be used to describe the various elements' relationships to one another, as illustrated in the accompanying drawings. These relative terms are intended to encompass different orientations of the device and/or elements in addition to the orientation depicted in the drawings. For example, if the device were inverted with respect to the view in the drawings, an element described as “above” another element, for example, would now be below that element.

The terms “substantial” or “substantially” mean to within acceptable limits or degrees acceptable to those of skill in the art. For example, the term “substantially parallel to” means that a structure or device may not be made perfectly parallel to some other structure or device due to tolerances or imperfections in the process by which the structures or devices are made. The term “approximately” means to within an acceptable limit or amount to one of ordinary skill in the art.

Where a first device is said to be connected or coupled to a second device, this encompasses examples where one or more intermediate devices may be employed to connect the two devices to each other. In contrast, where a first device is said to be directly connected or directly coupled to a second device, this encompasses examples where the two devices are connected together without any intervening devices other than electrical connectors (e.g., wires, bonding materials, etc.).

The term “memory” or “memory device,” as those terms are used herein, are intended to denote a computer-readable storage medium that is capable of storing computer instructions, or computer code, for execution by one or more processors. References herein to “memory” or “memory device” should be interpreted as one or more memories or memory devices. The memory may, for example, be multiple memories within the same computer system. The memory may also be multiple memories distributed amongst multiple computer systems or computing devices.

A “controller,” as that term is used herein encompasses an electronic component that is able to perform an algorithm in hardware, software and/or firmware. The controller may, for instance, be one or more microprocessors, one or more multi-core microprocessors, one or more microcontrollers, one or more state machines, one or more instances of combinational logic such as a programmable logic array (PLA) or a field programmable gate array (FPGA), one or more application specific integrated circuits (ASICs), or more digital signal processors (DSPs), etc. Instructions of a computer program or algorithm can be performed by multiple controllers that may be within the same computational device or that may be distributed across multiple computational devices.

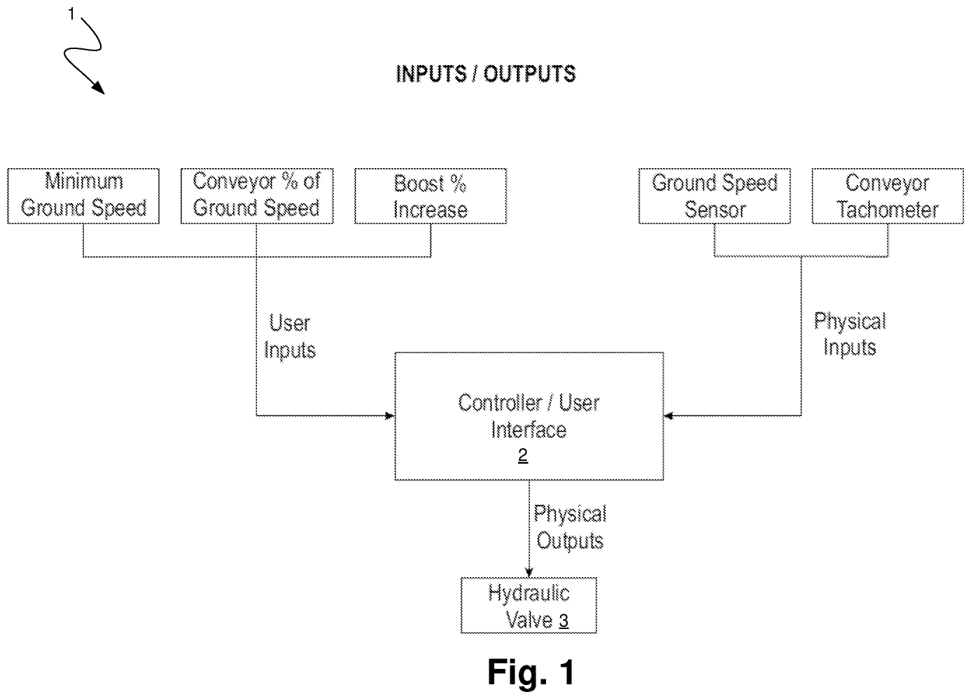

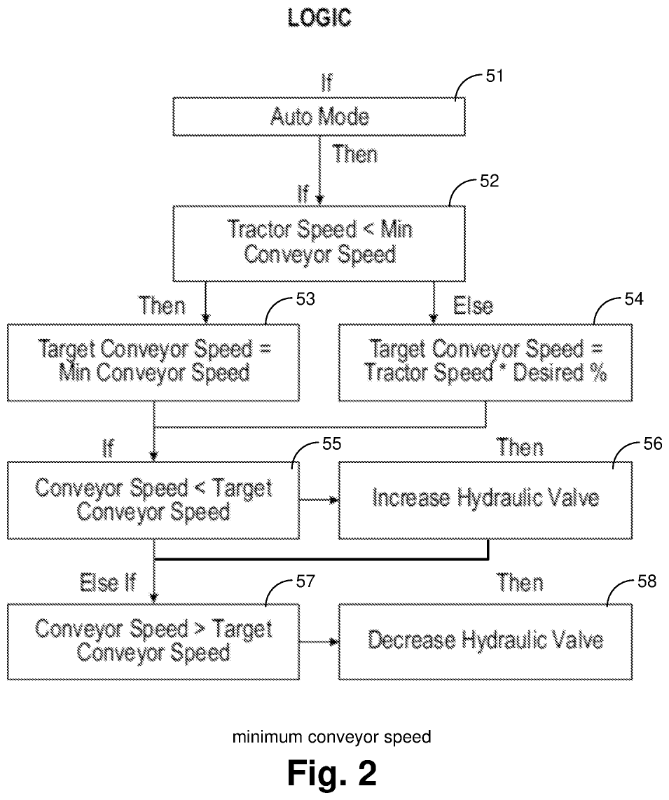

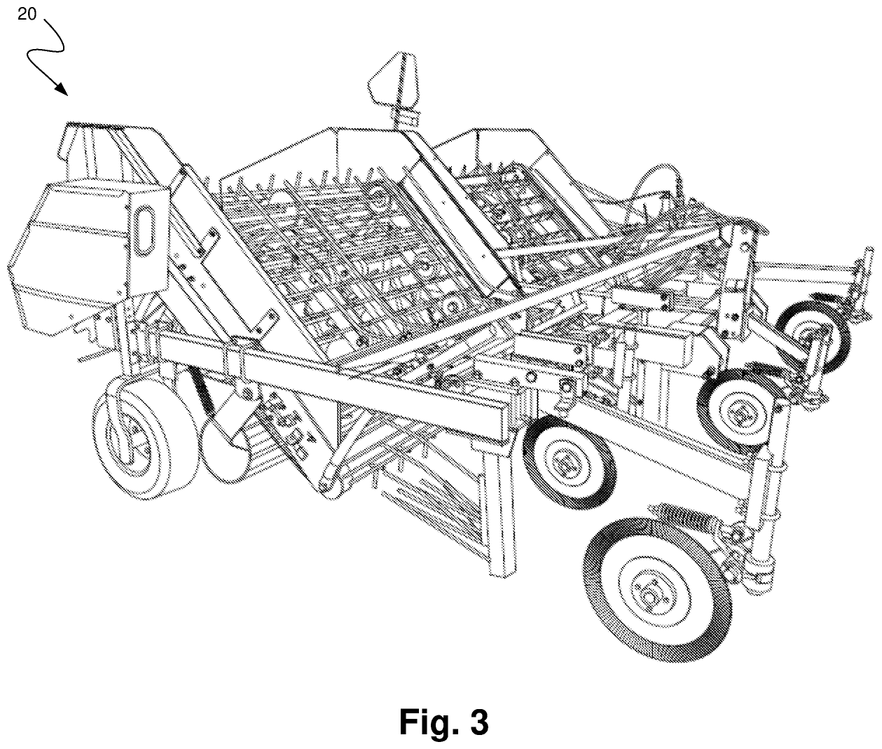

Referring now to the figures, FIG. 1 is a block diagram of the control system 1 in accordance with a representative embodiment showing examples of inputs received by a controller/user interface 2 of the control system 1, one or more outputs generated by the controller 2, and a control valve 3 that receives the outputs and controls the delivery of hydraulic fluid to a hydraulic motor of a digger-conveyor combination machine, such as the digger-conveyor combination machine 20 shown in FIG. 3. FIG. 2 is a flow diagram of the logic flow of the control system 1 of the present disclosure in accordance with a representative embodiment.

The control system 1 of the present disclosure can be fitted or retrofitted to a digger-conveyor combination machine 20 of the type shown in FIG. 3, and can be used to control the conveyor speed of the machine 20 relative to the ground speed in a number of different circumstances, such as the four non-limiting embodiments and examples given below.

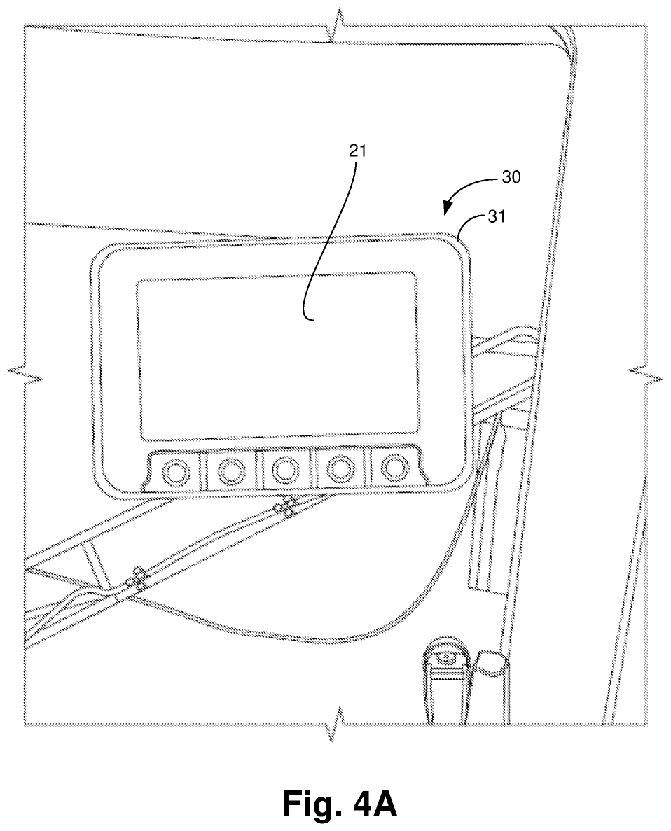

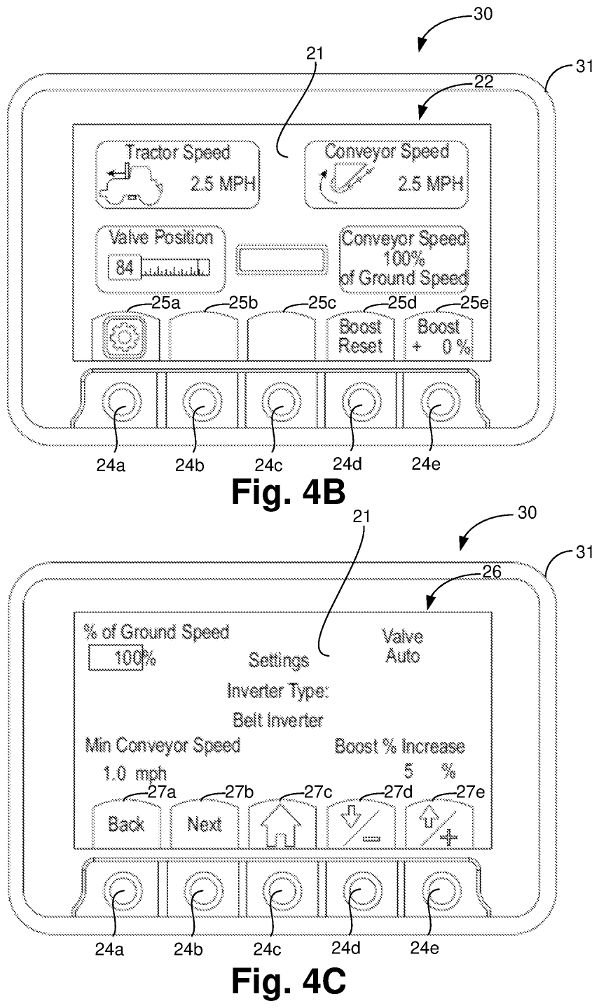

FIG. 4A shows a representative embodiment of a controller module 30 that comprises the controller/user interface 2 of the control system 1 shown in FIG. 1 for controlling the valve 3 shown in FIG. 1. The controller module 30 can be, for example, mounted on the window of a representative tractor suitable for use with the present invention for pulling a digger-conveyor combination machine such as the machine 20 shown in FIG. 3. The controller module 30 comprises suitable computer/digital hardware and software components for carrying out the method, a touch-screen input device 21 for inputting the desired parameters, a controller, such as a proportional-integral-derivative (PID) controller, for example (not shown), for carrying out an algorithm for operating the hydraulic valve 3 (FIG. 1), one or more outputs for sending instructions to the valve 3, and a controller module housing 31.

FIG. 4B shows the controller module 30 of FIG. 4A with a first representative display screen 22 showing tractor speed, conveyor speed, valve position, and conveyor speed as a percentage of ground speed. This screen 22 also shows five input keys 24a-24e along the bottom, which can be used to select settings icons 25a-25e, respectively, or the settings icons 25a-25e can be selected by the user touching the display screen 22. In the screen 22, input keys 24a-24c are operative for “settings” (the settings icon) 25a-25c, respectively, input key 24d is operative for “Boost Reset” 25d for resetting the Boost percent to zero or another coded value, and input key 24e is operative for “Boost+0%” 25e for raising (or lowering if so coded) the Boost percent. These various parameters and settings are discussed in more detail in connection with the Examples below.

FIG. 4C shows the controller module 30 of FIG. 4A with a second representative display screen 26 displayed on the touchscreen input device 21 showing exemplary settings. On this screen 26, the settings of the control system 1 and the valve are shown, such as “% of Ground Speed”, “Valve” setting (“Auto” in this screen, but can be “Manual” or any other coded setting), “Inverter Type:” setting (“Belt Inverter” in this screen, and can be other types of inverters if so coded), “Min Conveyor Speed” setting (“1.0 mph” in this screen), and “Boost % Increase” setting (“5%” in this screen). This screen 26 also shows that the five input keys 24a-24e are operative for changing settings 27a-27e, respectively, corresponding to “Back” 27a (moving to the previous screen in the screen sequence), “Next” 27b (moving to the next screen in the screen sequence), “home” 27c (the Home icon, for moving to the home screen in the screen sequence), “down/−” 27d (the Down arrow and a minus sign, for decreasing the value of a parameter, such as the “% of Ground Speed”, etc.), and “up/+” 27e (the UP arrow and a plus sign, for increasing the value of a parameter, such as the “% of Ground Speed”, etc.). Several of these various parameters and settings are discussed in more detail in connection with the Examples below.

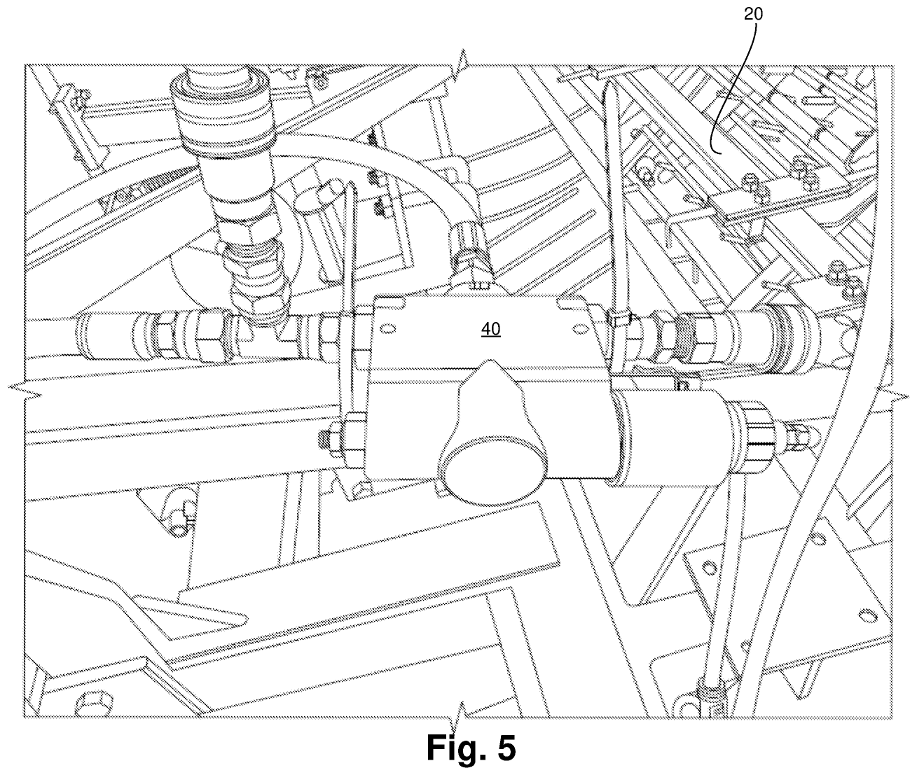

FIG. 5 shows a representative electronic flow control valve system 40 that includes the hydraulic valve 3 operated by the controller module 30 of FIGS. 4A-4C and mounted on the representative digger-conveyor combination machine 20 of FIG. 3, or some other digger-conveyer combination machine that is suitable for use with the present invention. In accordance with a first non-limiting representative embodiment, the valve system 40 is part of a hydraulic circuit between a hydraulic motor (not shown) of the digger-conveyor combination machine 20 that drives the conveyor and a hydraulic connection point on a tractor (not shown) that pulls the machine 20 and delivers hydraulic fluid to the machine 20 to power the conveyor.

The digger-conveyer combination machine 20 is configured to dig peanut pods from below ground level and place the peanut pods and attached vine material on top of the ground. The machine 20 uses a conveyor to elevate and relocate the peanut pods and attached plant material and the conveyor is powered by a hydraulic motor of the machine 20. This first representative embodiment is well suited for retrofitting an existing digger-conveyor combination machine by mounting the electronic control valve system 40 on the digger-conveyor combination machine 20 and interposing it between the hydraulic connection point of the tractor and the hydraulic connection point of the hydraulic motor of the digger-conveyor combination machine 20.

With reference again to FIG. 1, the controller/user interface 2 of the control system 1 inputs the ground speed of the machine 20 in the direction of travel and the conveyor speed, which is also the speed of the tractor that pulls the machine 20. The controller/user interface 2 outputs a control signal to the electronic flow control valve 3. The controller/user interface 2 performs an algorithm that compares the ground speed and the conveyor speed and varies the control signal that is output to the valve 3 so that the conveyor speed is maintained at a preselected percentage of ground speed. In accordance with a preferred embodiment, the preselected percentage of ground speed is a user-controlled variable that can be adjusted on the go through the user interface of the controller module 30.

As indicated above, the controller of the controller/user interface 2 preferably is a PID controller. In the automatic mode (auto mode) of the control system 1, the PID controller compares the ground speed with a threshold (TH) value equal to the preselected (e.g., user-defined) percentage of ground speed and generates an error value equal to the difference. The control signal that is output from the PID controller to the valve 3 increases or decreases the duty cycle of a pulse width modulated (PWM) signal that is delivered to the valve 3 to increase or decrease the flow of hydraulic fluid to the hydraulic motor of the conveyor to cause the speed of the conveyor to be maintained at the preselected (e.g., user-defined) percentage of ground speed.

A representative embodiment of the operations performed by the PID controller in the auto mode are shown in the flow diagram of FIG. 2. When the control system 1 is operating in the auto mode represented by block 51, the controller compares the tractor speed to the minimum conveyor speed. If a determination is made at block 52 that the tractor speed is less than the minimum conveyor speed, then the controller sets the target conveyor speed to be equal to the minimum conveyor speed at block 53. If a determination is made at block 52 that the tractor speed is not less than the minimum conveyor speed, then the controller sets the target conveyor speed to be equal to the preselected percentage of the tractor speed, as indicated by block 54.

The process proceeds from blocks 53 or 54 to block 55 at which the controller determines whether the actual conveyor speed is less than the target conveyor speed. If so, the hydraulic valve 3 is adjusted to increase the flow of hydraulic fluid to the conveyor, thereby increasing the speed of the conveyor, as indicated by block 56. Otherwise, the process proceeds from block 55 to block 57 at which the controller determines whether the actual conveyor speed is greater than the target conveyor speed. If so, the hydraulic valve 3 is adjusted to decrease the flow of hydraulic fluid to the conveyor, thereby decreasing the speed of the conveyor, as indicated by block 58. The process can then return to blocks 52 or 55, depending on the particular implementation of the method, and continue the feedback loop.

Many variations can be made to the method, a few examples of which will now be described.

### Example 1

The preselected, user-defined percentage of ground speed is 85% and the tractor is traveling at 3 mph. The control system 1 will perform the method described above with reference to FIG. 2 to adjust the flow control valve 3 such that the conveyor speed is maintained at approximately 2.5 mph, which is approximately 85% of 3 mph. If the tractor speed is reduced to 2.5 mph, the control system will reduce the conveyor speed to 2.1 mph, which is approximately 85% of 2.5 mph.

A second non-limiting and exemplary embodiment of the control system 1, which will be used as a second illustrative embodiment for the purposes of this disclosure, is a control system as described in the first embodiment above, but where the user interface of the controller module 30 provides the user with the ability to rapidly increase the conveyor speed by multiples of a user-defined percentage of current ground speed or a user-defined speed increment, a “Boost” button 25e, 27e (FIGS. 4B and 4C), on the go.

### Example 2

The operator approaches a section of the peanut field with a lot of weeds in addition to the peanut plants. The operator, who has set the “Boost” speed increment to 5%, or approximately 0.2 mph based on a digger ground speed of 3 mph, can select the “Boost” button 25e, 27e on the user interface to increase current conveyor speed by 5% of the ground speed, or 0.2 mph, to help move additional material on the conveyor. If a single “Boost” is not sufficient, “Boost” can be selected multiple times until the desired conveyor speed is achieved.

A third non-limiting and exemplary embodiment of the control system 1, which will be used as a third illustrative embodiment for the purposes of this disclosure, is a control system as described in the first embodiment above where the user interface has been provided with the option to change from automatic conveyor speed control to manual speed control on the go by selecting “Manual” mode. This can be accomplished, for example, by selecting the “Home” button 27c to cause another screen to be displayed that provides Manual mode and Auto mode icons. Once “Manual” mode is selected, the control system 1 changes conveyor speed based on manual user inputs and disregards the ground speed input. The user interface provides the user with the option to return to automatic conveyor speed control at any point by selecting Auto mode.

### Example 3A

The operator approaches an obstacle in the field and decreases ground speed and selects the “Manual” mode on the user interface of the controller module 30 to maintain the conveyor speed at the previous ground speed.

### Example 3B

As part of servicing the peanut digger, the operator will leave the tractor in a parked position and select the “Manual” mode on the user interface of the controller module 30. The operator can then use buttons 27d, 27e to increase or decrease conveyor speed as desired while the ground speed input remains zero.

A fourth non-limiting and exemplary embodiment of the control system 1, which will be used as a fourth illustrative embodiment for the purposes of this disclosure, is a control system as described in the first embodiment above where there is a minimum conveyor speed variable that can be set by the user, as show in screen 25 of FIG. 4C. The minimum conveyor speed is used to decrease lag time adjusting conveyor speed to ground speed when the tractor increases speed from stationary to operating speed.

### Example 4A

The minimum conveyor speed is critical to cleaning the conveyor at the end of the row when the tractor reduces ground speed to 0 mph prior to turning around. In this example, the control system 1 is programmed to recognize when the tractor has slowed to 0 mph, or to below a certain preset speed, such that the conveyor will not stop moving as the tractor makes the turn.

### Example 4B

The minimum conveyor speed can also be used as an alternative to the “manual” mode when performing service/maintenance work. In this example, the control system 1 is programmed to recognize when the tractor has slowed to 0 mph, such that the conveyor will not stop moving when the tractor is idling for service or maintenance.

Thus, the control system 1 of the present disclosure provides for setting the conveyor speed relative to the ground speed of the tractor, wherein the conveyor speed rate relative to the ground speed rate is made by an adjustment to the conveyor speed based on a percentage of the ground speed, such as, but not limited to, 80%-120% of the ground speed, more preferably 85%-115% of the ground speed, and even more preferably approximately 85% of the ground speed for Virginia peanuts and 115% of ground speed for runner peanuts. Alternatively, the conveyor speed rate relative to the ground speed is made by an adjustment to the conveyor speed based on a user set quantity, such as, but not limited to, ±0.1 mph-1.0 mph, more preferably ±0.1 mph-0.7 mph, and even more preferably ±0.1 mph-0.5 mph.

Further, the control system 1 of the present disclosure provides for rapidly increasing the rate of the conveyor speed relative to the ground speed by multiples of a user defined percentage, such as, but not limited to, 1.0%-10% of the ground speed, more preferably 1.0%-7.0% of the ground speed, and even more preferably 1.0%-5.0% of the ground speed. Alternatively, the control system of the present disclosure provides for rapidly increasing the rate of the conveyor speed relative to the ground speed based on a set quantity, such as, but not limited to, ±0.1 mph-0.5 mph, more preferably ±0.1 mph-0.3 mph, and even more preferably ±0.1 mph-0.2 mph.

As indicated above, one embodiment of the control system 1 and method outputs an electronic signal to the external flow control valve 40 mounted between the hydraulic motor on the digger-conveyor combination machine 20 and the hydraulic ports on the rear of the tractor. Current tractors use electronic flow controls to control the flow coming out of the tractor hydraulic ports. Often, one cannot access the tractor control system to control the onboard flow control valve of the tractor hydraulic system, which is a reason why this embodiment uses the external flow control to the hydraulic valve 40.

However, it is within the inventive principles and concepts to access the onboard flow control valve of the tractor if access to the onboard flow control valve of the tractor is allowed or desired. This would eliminate the need for the external flow control valve. In this manner, the current invention also would allow use of the onboard flow control by accessing the tractor control system to control the conveyor speed on the digger-shaker. In such an alternative embodiment, the invention would still use identical or similar interfaces and algorithms, but the signal would be sent to the tractor control system instead of the outboard flow control valve.

In accordance with another embodiment, the tractor that is used with the digger/conveyor combination machine 20 is configured to implement the ISO 11783 standard, also commonly referred to as the ISOBUS protocol. The ISOBUS protocol is a communications protocol for tractors and machinery for agriculture and forestry. The ISOBUS standard specifies a serial data network for control and communications on tractors and implements. In accordance with this embodiment, the control system 1 interfaces with or is integrated with the control system of the tractor that implements the ISOBUS communications protocol. This would allow the user to achieve the functionality described above in the examples by interacting with the user interface of the controller module 30 and/or of the tractor to control the onboard flow control valve of the tractor's hydraulic system to thereby control the flow of hydraulic fluid to the conveyor. The flow of hydraulic fluid to the conveyor will then be varied in the manner described above without the need for the external flow control valve 40 shown in FIG. 5.

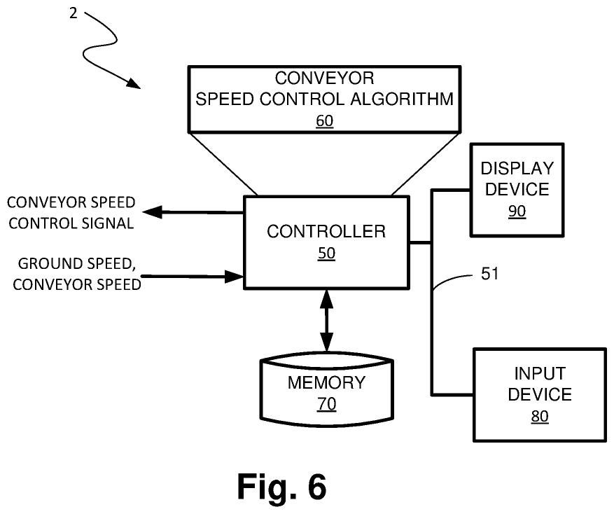

FIG. 6 illustrates a block diagram of the controller/user interface 2 shown in FIG. 1 in accordance with a representative embodiment. A controller 50 is configured to execute a conveyor speed control algorithm 60 to perform the operations described above with reference to FIG. 2 and the examples. The computer code comprising the algorithm 60 may be stored in a memory device 70 that is accessed by the controller 50. The memory device 70 can be any suitable non-transitory computer-readable medium. A display device 90, which can be the display screen of the touch-screen input device 21, displays information to the user, such as the screens shown in FIGS. 4A-4C.

The controller 50 receives input from an input device 80, which can be the input portion of the touch-screen input device 21 shown in FIGS. 4A-4C, as well as the ground speed and conveyor speed and performs the operations described above under control of the algorithm 60. The inputs that are received in the controller 50 from the input device 80 can vary depending on the manner in which the algorithm 60 is implemented and/or depending on whether the controller module 30 is operating in Auto mode or Manual mode. The conveyor speed control signal is output from the controller 50 and sent to the hydraulic valve to control the flow of hydraulic fluid to the conveyor to thereby control the speed of the conveyor. The link between the controller 50 and the valve can be a wired link or a wireless link.

Certain steps in the processes or process flows described in this specification naturally precede others for the invention to function as described. However, the invention is not limited to the order of the steps described if such order or sequence does not alter the functionality of the invention. That is, it is recognized that some steps may be performed before, after, or parallel (substantially simultaneously with) other steps without departing from the scope and spirit of the invention. In some instances, certain steps may be omitted or not performed without departing from the invention.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM, flash memory, or other optical disk storage, magnetic disk storage or other magnetic storage devices, or any other medium that may be used to carry or store desired program code in the form of instructions or data structures and that may be accessed by a computer.

Although a few embodiments have been described in detail above, those skilled in the art will readily appreciate that many modifications are possible in the embodiments without materially departing from this disclosure. Accordingly, such modifications are intended to be included within the scope of this disclosure as defined in the following claims. In the claims, means-plus-function clauses are intended to cover the structures described herein as performing the recited function and not only structural equivalents, but also equivalent structures. It is the express intention of the applicant not to invoke 35 USC § 112(f) for any limitations of any of the claims herein, except for those in which the claim expressly uses the words ‘means for’ together with an associated function.

The various embodiments are provided by way of example and are not intended to limit the scope of the disclosure. The described embodiments comprise different features, not all of which are required in all embodiments of the disclosure. Some embodiments of the present disclosure utilize only some of the features or possible combinations of the features. Variations of embodiments of the present disclosure that are described, and embodiments of the present disclosure comprising different combinations of features as noted in the described embodiments, will occur to persons with ordinary skill in the art. It will be appreciated by persons with ordinary skill in the art that the present disclosure is not limited by what has been particularly shown and described herein above. Rather the scope of the invention is defined by the appended claims.

What is claimed is:

1. A control system for use on a peanut digger-conveyor combination machine that digs peanut pods from below ground level and places the peanut pods and attached vine material on top of the ground and uses a conveyor to elevate and relocate the peanut pods and attached plant material, and wherein a conveyor of the machine is powered by a hydraulic motor, the machine moving at a ground speed in a direction of travel and the conveyor conveying at a conveyor speed, wherein the control system comprising:
a controller configured to:
input the ground speed;
input the conveyor speed;
output a conveyor speed control signal to a flow varying device that is part of a hydraulic circuit that provides hydraulic power to the conveyor; and
perform a conveyor speed control algorithm that compares the ground speed with the conveyor speed and varies the conveyor speed control signal output to the flow varying device so that the conveyor speed is maintained at a preselected percentage of the ground speed.

2. The control system according to claim 1, wherein the control system further comprises a user interface (UI) that is in communication with the controller, and wherein the preselected percentage of the ground speed is a user-controlled variable that can be adjusted by a user on the go through the UI.

3. The control system according to claim 2, wherein the UI is configured to allow a user to rapidly increase the preselected percentage of the ground speed.

4. The control system according to claim 2, wherein the UI is configured to allow a user to change from an Auto mode during which the controller automatically varies the conveyor speed control signal to maintain the conveyor speed at the preselected percentage of the ground speed to a Manual mode during which the user can cause the control system to change the conveyor speed by making one or more user inputs on the UI to manually set the conveyor speed to a desired conveyor speed.

5. The control system according to claim 4, wherein in the Manual mode, the control system changes the conveyor speed based on said one or more user inputs and disregards the ground speed input.

6. The control system according to claim 5, wherein the UI further provides an ability for the user to return to the Auto mode from the Manual mode at any point in time.

7. The control system according to claim 2, wherein the UI provides the user with the ability to set a minimum conveyor speed variable that the controller uses to set the conveyor speed control signal to thereby set the conveyor speed to a minimum conveyor speed.

8. The control system according to claim 7, wherein the minimum conveyor speed is used to decrease lag time in adjusting the conveyor speed to the preselected percentage of the ground speed when the machine increases speed from stationary to operating speed.

9. The control system according to claim 1, wherein the preselected percentage of the ground speed is a user-defined percentage set by a user.

10. The control system according to claim 2, wherein the UI provides a user with an ability to rapidly increase the conveyor speed by multiples of the preselected percentage.

11. The control system according to claim 2, wherein the UI provides the user with an ability to rapidly increase the conveyor speed by a user-defined speed increment.

12. The control system according to claim 1, wherein the flow varying device is an electronic flow control valve for varying the flow of hydraulic fluid in the hydraulic circuit.

13. The control system according to claim 12, wherein the hydraulic circuit comprises a first hydraulic circuit portion disposed on the digger-conveyor combination machine and a second hydraulic circuit portion disposed on a tractor that is coupled to the digger-conveyor combination machine, the first and second hydraulic circuit portions being coupled together at a tractor connection point on the tractor, and wherein the electronic flow control valve is part of the first hydraulic circuit portion.

14. The control system according to claim 12, wherein the hydraulic circuit comprises a first hydraulic circuit portion disposed on the digger-conveyor combination machine and a second hydraulic circuit portion disposed on a tractor that is coupled to the digger-conveyor combination machine, the first and second hydraulic circuit portions being coupled together at a tractor connection point on the tractor, the electronic flow control valve being disposed on the tractor, the control system being in communication with, or an integral part of, a control system of the tractor that performs ISOBUS protocol.

15. A method for controlling a conveyor of a digger-conveyor combination machine that digs peanut pods from below ground level and places the peanut pods and attached vine material on top of the ground and uses a conveyor to elevate and relocate the peanut pods and attached plant material, and wherein the conveyor is powered by a hydraulic motor, the machine moving at a ground speed in a direction of travel and the conveyor conveying at a conveyor speed, the method comprising:
in a controller of the control system:
inputting the ground speed;
inputting the conveyor speed; and
performing a conveyor speed control algorithm that compares the ground speed with the conveyor speed and varies a conveyor speed control signal output to a flow varying device that is part of a hydraulic circuit that provides hydraulic power to the conveyor to maintain the conveyor speed at a preselected percentage of the ground speed.

16. The method according to claim 15, wherein the control system further comprises a user interface (UI) that is in communication with the controller, and wherein the preselected percentage of the ground speed is a user-controlled variable that can be adjusted by a user on the go through the UI.

17. The method according to claim 15, wherein the flow varying device is an electronic flow control valve for varying the flow of hydraulic fluid in the hydraulic circuit.

18. The method according to claim 17, wherein the hydraulic circuit comprises a first hydraulic circuit portion disposed on the digger-conveyor combination machine and a second hydraulic circuit portion disposed on a tractor that is coupled to the digger-conveyor combination machine, the first and second hydraulic circuit portions being coupled together at a tractor connection point on the tractor, and wherein the electronic flow control valve is part of the first hydraulic circuit portion.

19. The method according to claim 17, wherein the hydraulic circuit comprises a first hydraulic circuit portion disposed on the digger-conveyor combination machine and a second hydraulic circuit portion disposed on a tractor that is coupled to the digger-conveyor combination machine, the first and second hydraulic circuit portions being coupled together at a tractor connection point on the tractor, the electronic flow control valve being disposed on the tractor, the control system being in communication with, or an integral part of, a control system of the tractor that performs ISOBUS protocol.

20. A computer program comprising instructions for execution by a controller of a control system for controlling a conveyor of a digger-conveyor combination machine that digs peanut pods from below ground level and places the peanut pods and attached vine material on top of the ground and uses a conveyor to elevate and relocate the peanut pods and attached plant material, and wherein the conveyor is powered by a hydraulic motor, the machine moving at a ground speed in a direction of travel and the conveyor conveying at a conveyor speed, the computer program being embodied on a non-transitory computer-readable medium and comprising:
a first set of instructions for inputting the ground speed in the controller;
a second set of instructions for inputting the conveyor speed;
a third set of instructions for performing a conveyor speed control algorithm that compares the ground speed with the conveyor speed and produces a conveyor speed control signal; and
a fourth set of instructions that output the conveyor speed control signal from the controller to a flow varying device that is part of a hydraulic circuit that provides hydraulic power to the conveyor, wherein the conveyor speed control signal is varied by the third set of instructions to maintain the conveyor speed at a preselected percentage of the ground speed.
